(19) United States
(12) Patent Application Publication
(10) Pub. No.: US 2011/0230219 A1
(43) Pub. Date: Sep. 22, 2011

(54) METHOD AND APPARATUS FORINTER-CELL ITNERFERENCE MITGATION THROUGH ENHANCED PREFERRED FREQUENCY REUSE MECHANISMS

(75) Inventors: William N. Shores, Phoenix, AZ (US); Rajeev Agrawal, Northbrook, IL (US); Anand S. Bedekar, Arlington Heights, IL (US); Guang Han, Arlington Heights, IL (US); Shawn W. Hogberg, Chandler, AZ (US); Suresh Kalyanasundaram, Bangalore (IN); Vivek P. Mhatre, Schaumburg, IL (US); Daniel R. Tayloe, Phoenix, AZ (US)

(73) Assignee: MOTOROLA, INC., Libertyville, IL (US)

(21) Appl. No.: 13/041,496

(22) Filed: Mar. 7, 2011

(30) Foreign Application Priority Data
Mar. 16, 2010 (IN) 611/DEL/2010

(51) Int. Cl. H04B 7/24

(52) U.S. Cl. 455/507

(57) ABSTRACT

In a wireless communication system, a method includes assigning an initial portion of a list of resource block group for each of a plurality of cells such that the resource block groups are spread across the plurality of cells in a non-contiguous order spaced out in frequency. In addition, the method assigns a secondary portion of the list of resource block groups for each of a plurality of cells wherein the secondary portion is assigned in a reverse order and alternating from the initial portion of the list of resource block groups of each of the other plurality of cells.

### FIELD OF THE INVENTION

The present invention relates generally to resource allocation in a wireless communication system and in particular, to downlink resource allocation for Long Term Evolution wireless communication system to reduce inter-cell interference and susceptibility to fading by exploiting resource block groups and subset interleaving.

### BACKGROUND

In the Long Term Evolution (LTE) standard of wireless communication systems, a given frequency spectrum can be divided into resource blocks. A resource block can be either a physical resource block or a virtual resource block of distributed type where a frequency hopping happens at the slot boundary in the middle of a subframe as defined in the 3 GPP specification TS 36.211. Moreover, resource blocks can be group together in groups of, for example, three resource blocks to form resource block groups. It is understood, however, that a resource block group can contain any number of resource blocks including a signal resource block. It should be also understood that a resource block group can contain non-contiguous resource blocks including both physical resource blocks as well as virtual resource blocks. In a given frequency spectrum, such as 10 MHz, the frequency spectrum can be made up of 16 resource block groups that include 3 resource blocks and a 17^{th} resource block group that has 2 resource blocks. In addition, LTE includes three distinct Resource Allocation Types (RAT), RAT 0, RAT 1 and RAT 2. RATs 0 and 1 allow for non-contiguous resource block allocation to user equipment on the Physical Downlink Shared Channel (PDSCH) between an access point and the user equipment.

Due to spectrum scarcity in LTE and other similar wireless communication systems, a frequency reuse factor of 1 is often used. This causes the same frequency resources to be shared by neighboring cells. At the same time, it is important to support intercell interference mitigation to therefore improve cell throughput. In addition, fading characteristics for resource blocks that are far apart in frequency tend to be independent of one another since the system bandwidth of the wide-band systems (5 MHz, 10 MHz, 15 MHz of wide-band communications such as LTE) is large enough. Fading of a given resource block can be highly volatile and unpredictable.

To minimize Physical Downlink Control Channel (PDCCH) overhead, LTE does not support direct bitmap allocation, where each bit indicates a particular resource block, for bandwidth system that include more than 10 resource blocks. It is therefore difficult to assign an arbitrary set of resource blocks to a given user equipment. LTE therefore provides for the RATs 0-2 to limit the resource block assignment patterns. This limitation can lead to performance degradation because a given user equipment may not be assigned to the best resource block or resource block group that is available. For example, the same resource block in different cells or sectors can be assigned to different user equipment. Thus, overlap in cells and resource groups can grow as interference between cells and resource groups also grows.

Schemes and models have been developed to reduce overlap of resource group assignment and interference. Often, these allocation schemes use interference measurements across the plurality of cells. The allocation schemes therefore rely on interference measurements and are constantly changing.

In view of the foregoing, it is desired to determine a particular allocation ordering scheme across cells that reduce interference and load across cells or sectors and maintain frequency diversity.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example wireless communications system that utilize the principles described and are in accordance with some embodiments of the invention.

FIG. 2 is an example of resources assigned to a channel using resource blocks, resource block groups and subsets and is in accordance with some embodiments of the invention.

FIG. 3 is an example of resource block groups assigned to cells in various system bandwidths in accordance with some embodiments of the invention.

FIG. 4 is an example of the assignment of user equipment using the resource block group lists created in accordance with some embodiments of the invention.

FIG. 5 is another example of the assignment of user equipment using the resource block group lists created in accordance with some embodiments of the invention.

FIG. 6 is also an example of the assignment of user equipment using the resource block group lists created in accordance with some embodiments of the invention.

FIG. 7 is a flow diagram of the assignment of user equipment using the resource block group lists created in accordance with some embodiments of the invention.

FIG. 8 is an example of the assignment of user equipment to resource groups in a fully loaded or nearly fully loaded frequency bandwidth according to principles of the present invention.

FIG. 9 is another example of the assignment of user equipment to resource groups in a fully loaded or nearly fully loaded frequency bandwidth according to principles of the present invention.

FIG. 10 is also an example of the assignment of user equipment to resource groups in a fully loaded or nearly fully loaded frequency bandwidth according to principles of the present invention.

FIG. 11 is yet another example of the assignment of user equipment to resource groups in a fully loaded or nearly fully loaded frequency bandwidth according to principles of the present invention.

FIG. 12 is a further example of the assignment of user equipment to resource groups in a fully loaded or nearly fully loaded frequency bandwidth according to principles of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to inter-cell interference mitigation through enhanced preferred frequency reuse mechanism and using assignment of resource block and resource block groups and allocation of user equipment to the resource bocks and resource block groups. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of inter-cell interference mitigation through enhanced preferred frequency reuse mechanism and using assignment of resource block and resource block groups and allocation of user equipment to the resource bocks and resource block groups as described herein. The non-processor circuits may include, but are not limited to, a radio receiver, a radio transmitter, signal drivers, clock circuits, power source circuits, and user input devices. As such, these functions may be interpreted as steps of a method to perform distribution of resource block groups and the allocation of user equipment to the distributed resource block groups. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

As described below, a method and an apparatus that includes a transceiver and a processor couple to the transceiver where the processor is configured to perform the described method is disclosed. In a wireless communication system, the disclosed method includes assigning an initial portion of a list of resource block group for each of a plurality of cells such that the resource block groups are spread across the plurality of cells in a non-contiguous order spaced out in frequency. In addition, the method assigns a secondary portion of the list of resource block groups for each of a plurality of cells wherein the secondary portion is comprised of the initial portion of the list of resource block groups of each of the other plurality of cells. In an embodiment, the secondary portion is assigned in a reverse order and alternating from the initial portion of the list of resource block groups of each of the other plurality of cells.

The user equipments can be assigned resource blocks in an order based on their relative channel conditions. In an embodiment, the user equipment with the weakest channel condition will be the first to be assigned resource blocks and the user equipment with the strongest channel condition will be the last to be assigned resource blocks.

The allocation of user equipment to the assigned list of resource block groups can also be achieved in different ways. In an embodiment, user equipment is allocated to the assigned list of resource block groups in a sequential order of the assigned resource block groups of the initial portion and the secondary portion. In another embodiment, the allocation method of the secondary portion can be altered such that user equipment is allocated according to a buffer size of the user equipment. While a user equipment with large buffer size that requires a large number of resource block groups can simply follow the sequential order of the assigned list, a user equipment with small buffer size that requires a small number (e.g. <=3) of resource block groups may not follow the assigned list and it can be allocated resource blocks only within a selected subset of the resource block groups so that RAT 1 can be used to address the resource blocks directly. In this way, the allocation of resource block groups with more than the necessary number of resource blocks to a user equipment with small buffer size can be avoided. The resource block groups can also be allocated to maximize packing.

Alternatively, the method provides for allocating the initial portion of the list of resource block groups of a second cell to user equipment after the initial portion of the first cell is allocated when the user equipment served by the first cell measures larger interference in a third cell, and allocating the initial portion of the list of resource block groups of the third cell to user equipment after the initial portion of the second cell is allocated. A similar method can be done according to the load levels of the neighboring cells. For example, if the load of the second cell is very small, all user equipments served by the first cell are allocated the initial portion of the second cell before the initial portion of the third cell.

In addition to the allocation of dedicated user equipment transmissions, the principled discussed apply to the allocation of the assigned list may also apply for common control message transmissions such as broadcast message, paging message, random access response message, contention resolution message, CCCH message, and so on. In an embodiment, the resource blocks of the assigned list are allocated to common control message transmissions before dedicated user equipment messages. As for user equipment transmissions, the allocation of resource blocks to common control channels may be modified depending on the load of the other cells.

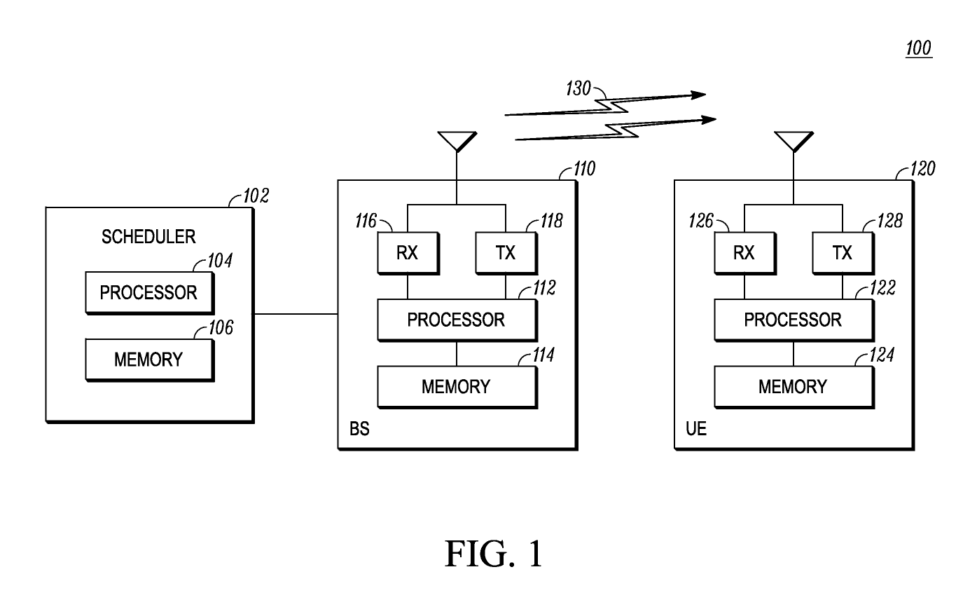

The present invention may be more fully described with reference to the figures. FIG. 1 is a block diagram of a wireless communication system 100 in accordance with an embodiment of the present invention. Communication system 100 includes a user equipment (UE) 120, such as but not limited to a cellular telephone, a radiotelephone, a smartphone or a Personal Digital Assistant (PDA), personal computer (PC), or laptop computer equipped for wireless communications. Communication system 100 further includes a base station (BS) 110 that provides communication services to users' equipment, such as UE 120, residing in a coverage area of the RAN via a radio link. Radio link comprises a downlink 130 and an uplink (not shown) that each comprises multiple physical and logical communication channels, including multiple traffic channels and multiple signaling channels. The multiple channels for the downlink 130 can include a Physical Downlink Control Channel (PDCCH) and a Physical Downlink Shared Channel (PDSCH).

Each of BS 110 and UE 120 and includes a respective processor 112, 122, such as one or more microprocessors, microcontrollers, digital signal processors (DSPs), combinations thereof or such other devices known to those having ordinary skill in the art, which processor is configured to execute the functions described herein as being executed by the BS and UE, respectively. Each of BS 110 and UE 120 further includes a respective at least one memory device 114, 124 that may comprise random access memory (RAM), dynamic random access memory (DRAM), and/or read only memory (ROM) or equivalents thereof, that maintain data and programs that may be executed by the associated processor and that allow the BS and UE to perform all functions necessary to operate in communication system 100. Each of BS 110 and UE 120 also includes a respective radio frequency (RF) transmitter 118, 128 for transmitting signals over radio link 130 and a respective RF receiver 116, 126 for receiving signals via radio link 130. The transmitter 118, 128 and receiver 116, 126 are often referred to collectively as a transceiver.

Communication system 100 further includes a scheduler 102 that is coupled to BS 110 and that performs the scheduling functions described herein. Scheduler 102 includes a processor 104 such as one or more microprocessors, microcontrollers, digital signal processors (DSPs), combinations thereof or such other devices known to those having ordinary skill in the art, which processor is configured to execute the functions described herein as being executed by the scheduler. Scheduler 102 further includes an at least one memory device 106 that may comprise random access memory (RAM), dynamic random access memory (DRAM), and/or read only memory (ROM) or equivalents thereof, that maintains data and programs that may be executed by the associated processor and that allow the scheduler to perform all functions necessary to operate in communication system 100. While scheduler 102 is depicted as an element separate from BS 110, in other embodiments of the invention, scheduler 102 may be implemented in the BS, and more particularly by processor 112 of the BS based on programs maintained by the at least one memory device 114 of the BS.

The functionality described herein as being performed by scheduler 102, BS 110, and UE 120 is implemented with or in software programs and instructions stored in the respective at least one memory device 106, 114, 124 associated with the scheduler, BS, and UE and executed by the processor 104, 112, 122 associated with the scheduler, BS, and UE. However, one of ordinary skill in the art realizes that the embodiments of the present invention alternatively may be implemented in hardware, for example, integrated circuits (ICs), application specific integrated circuits (ASICs), and the like, such as ASICs implemented in one or more of the scheduler, BS, and UE. Based on the present disclosure, one skilled in the art will be readily capable of producing and implementing such software and/or hardware without undo experimentation.

In order for BS 110 and UE 120 to engage in a communication session, BS 110 and UE 120 each operates in accordance with known wireless telecommunications standards. Preferably, communication system 100 is a 3 GPP LTE (Third Generation Partnership Project Long Term Evolution) communication system that operates in accordance with the 3 GPP LTE standards. To ensure compatibility, radio system parameters and call processing procedures are specified by the standards, including call processing steps that are executed by the BS and UE. However, those of ordinary skill in the art realize that communication system 100 may be any wireless communication system that allocates radio link resources, such as a 3 GPP UMTS (Universal Mobile Telecommunication System) communication system, a CDMA (Code Division Multiple Access) communication system, a CDMA 2000 communication system, a Frequency Division Multiple Access (FDMA) communication system, a Time Division Multiple Access (TDMA) communication system, or a communication system that operates in accordance with any one of various OFDM (Orthogonal Frequency Division Multiplexing) technologies, such as a Worldwide Interoperability for Microwave Access (WiMAX) communication system or a communication system that operates in accordance with any one of the IEEE (Institute of Electrical and Electronics Engineers) 802.xx standards, for example, the 802.11, 802.15, 802.16, or 802.20 standards.

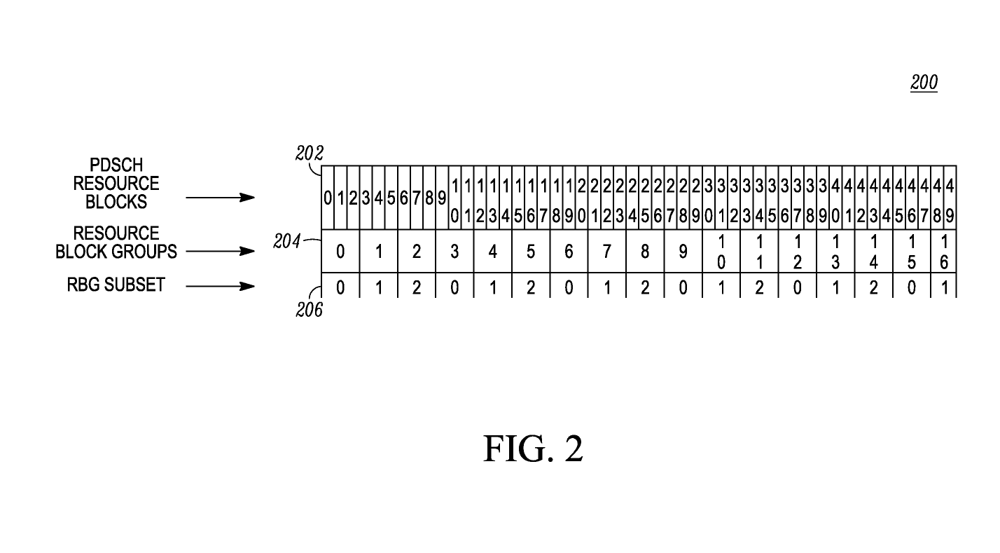

Turning to FIG. 2, it is understood that LTE operates in wide band frequencies using 5 MHz, 10 MHz, 20 MHz or even larger spectrums. These frequency spectrums are used for both uplink and downlink communications. In the downlink, a PDSCH 202 is divided into resource blocks 204 of a given frequency spectrum. In addition, the resource blocks can be grouped into resource block groups 206. In the example shown, the resource blocks are placed into groups of three so that the 50 resource blocks of the PDSCH are in 15 resource group blocks with two additional blocks, which is placed into a resource group block 16. The resource block groups can also separated into different subsets 208, wherein each subset is designated by the remainder of the resource block when the number of the resource block is divided by the number of resource blocks in a resource block groups. The example shown in FIG. 2 is for a 10 MHz system, and there are 50 resource blocks and each resource block group has 3 resource blocks so that there are 3 subsets. Resource block groups 0, 3, 6, 9, 13 and 15 are assigned subset 0, resource block groups 1, 4, 7, 10, 14 and 16 are assigned subset 1 and so on.

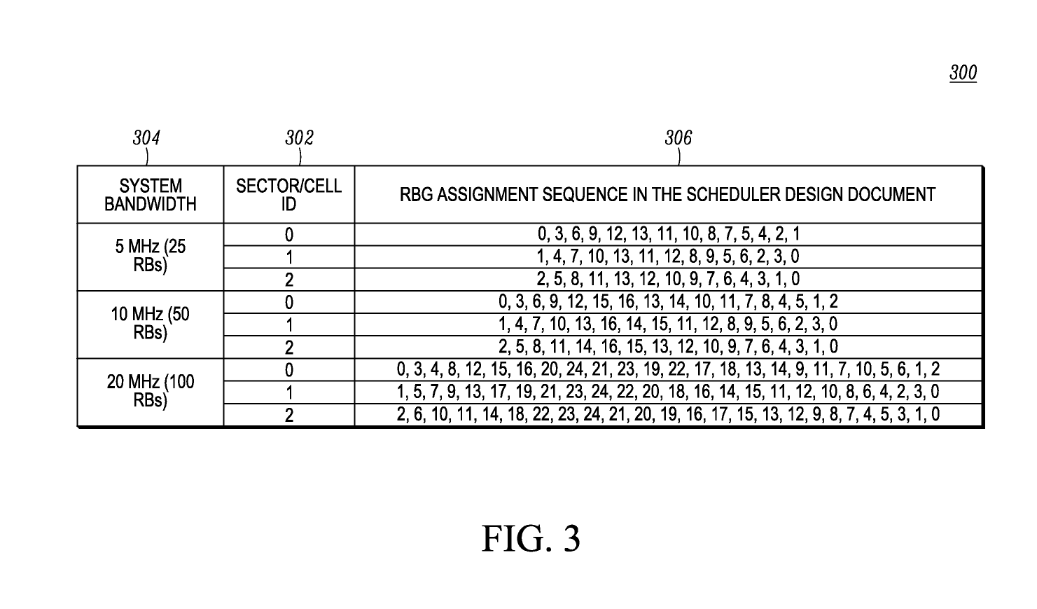

FIG. 3 illustrates table 300 showing the assignment and allocation by the scheduler 102 of resource block groups 206 for different wide band frequency spectrums. As seen, the scheduler's 102 assignment and allocation of the resource block groups 206 allow for minimized PDCCH overhead and provides for non-contiguous allocation of the resource block groups over the frequency spectrum and minimizes the interference and load between the frequencies and between sectors or cells in the system.

As is understood by LTE, each base station 110 can operate in multiple different orientations that are designated by the sector or cell ID 302. In the examples shown, there are 3 different cells in which the resource block groups are assigned. FIG. 3 illustrates the assignment in 3 different system bandwidths 304, 5 MHz, which has 25 resource blocks, 2 subsets and 12 resource block groups, 10 MHz with 50 resource blocks, 3 subsets and 16 resource block groups and 20 MHz with 100 resource blocks, 5 subsets and 24 resource block groups. According to the principles described below, the scheduler assigns and allocates the resource block groups across the cells so that each cell has a non-contiguous series of resource block groups that are spaced out through the frequency spectrum.

According to these principles described and using the 10 MHz frequency spectrum as an example, the resource block groups are assigned such that each of the resource block groups are assigned across each of the cells such that all of the resource block groups are assigned to an initial portion of a list of resource block groups. In the example shown, the resource block groups are sequential distributed between the cells so that cell 1 includes resource block groups 0, 3, 6, 9, 12 and 15, cell 2 includes resource block groups 1, 4, 7, 10 and 13 and cell 3 includes resource bock groups 2, 5, 8, 11 and 14.

After the list's initial portion is completed, the remaining resource block groups are assigned to a secondary portion of the list for each cell so that user equipment can be distributed or allocated to all the resource blocks in the cell. The secondary portion for each list begins with resource block group 16, which includes 2 resource blocks that are the remainder from the subsets. The remaining resource block groups are assigned to reduce the interference between the cells caused by assigning resource block groups to user equipment. Thus, a secondary portion of the list is created by assigning resource block groups from the least likely to be used resource block groups assigned to the other cells.

As an example, the secondary portion of the list for cell 0 takes the last assigned resource block group for the initial portion of cells 1 and 2 such that the secondary portion starts with resource block groups 13 and 14, the secondary portion for cell 1 starts with resource block groups 14 and 15 and the secondary portion for cell 2 starts with resource block groups 15 and 13. Thus, cell 0 has a list of assigned resource block groups of {0, 3, 6, 9, 12, 15, 16, 13, 14, 10, 11, 7, 8, 4, 5, 1, 2}, cell 1 has a list of assigned resource block groups {1, 4, 7, 10, 13, 16, 14, 15, 11, 12, 8, 9, 5, 6, 2, 3, 0} and cell 2 has a list of assigned resource block groups {2, 5, 8, 11, 14, 16, 15, 13, 12, 10, 8, 7, 6, 4, 3, 1, 0}. This method of assigning resource blocks can applied to different frequency bandwidths, different number of resource blocks and subsets as seen in FIG. 3. In an embodiment, the scheduler 102 maintains a list of resource block groups depending on the cell ID.

In an embodiment, the list of resource blocks as seen in FIG. 3 for each cell can be created according to a developed algorithm. The algorithm starts with the number of resources that are available for scheduling. The example described above, there are 16 resource block groups. The algorithm, however, can apply to a larger or smaller number of resource block groups or to individual resource blocks and other sorts of resource bundles. The number of resource block groups is given a designation of R and the set is {0, 1, . . . , R−1}. In addition, a frequency reuse N is determined such that the set of reuse is n={0, 1, . . . N−1}. The frequency reuse can be the number of cells across which the resource block groups are distributed. With the number of resource blocks groups and reuse, the resource block groups are assigned to the cells according to n[R/N]+{0, . . . , [R/N]−1}, where [R/N] represents a floor function for the assignment. In this way the initial portion of the list of resource block groups is distributed between the cells. After the initial portion of the list of resource blocks are assigned, the second portion of the list is assigned from the remaining resource blocks. They are assigned in a round-robin fashion using the initial portions of the list of resource blocks of the remaining cells. The round robin fashion of allocation is done by decreasing resource bundle group from the remaining cells. In other words, the resource bundle groups at the end of the initial portion of the lists are taken in order alternating between the remaining cells. In the embodiment described above, the frequency reuse is equivalent to the number of cells in which the resource block groups are distributed. In other words, the embodiment described distributes the resource block groups between the cells as a method of assignment. In this way, each of the resource block groups is allocated to a cell. The algorithm will generate the ordered list of resource block for each cell index as follows: cell index 0 {0, 3, 6, 9, 12, 15, 16, 14, 13, 11, 10, 8, 7, 5, 4, 2, 1}, cell index 1 {1, 4, 7, 10, 13, 15, 16, 12, 14, 9, 11, 6, 8, 3, 5, 0, 2} and cell index 2 {2, 5, 8, 11, 14, 15, 16, 13, 12, 10, 9, 7, 6, 4, 3, 1, 0}.

In an example where the number of resource block groups R is 17 and the set of reuse, or number of cells, n is 3, the initial portion of resource block groups assigned to cell index 0 is {0, 3, 6, 9, 12, 15}, cell index 1 is {1, 4, 7, 10, 13} and cell index 2 {2, 5, 8, 11, 14}. With the 17^{th} resource block group that has less resource blocks, the ordered list of resource block groups including the initial portion and secondary portion for cell index 0 is then {0, 3, 6, 9, 12, 15, 16, 13, 14, 10, 11, 7, 8, 4, 5, 1, 2} as shown in FIG. 2.

In another example, to facilitate allocating contiguous resource blocks to common control messages, the initial portion of resource block groups assigned to cell index 0 is {0, 1, 6, 7, 12, 13}, cell index 1 is {2, 3, 8, 9, 14, 15} and cell index 2 {4, 5, 10, 11, 16}. The ordered lists of resource block groups including the initial portion and secondary portion for cell index 0 are then {0, 1, 6, 7, 12, 13, 14, 15, 16, 11, 10, 9, 8, 5, 4, 3 2}, cell index 1 {2, 3, 8, 9, 4, 15, 16, 13, 12, 11, 10, 7, 6, 5, 4, 1, 0} and cell index 2 {4, 5, 10, 11, 16, 12, 13, 14, 15, 9, 8, 7, 6, 3, 2, 1, 0}, respectively.

In yet another example, to facilitate allocating virtual resource blocks of distributed type to common control messages as well as allocating physical resource blocks to dedicated user equipment transmissions, we introduce the notion of virtual resource block groups (VRBG) where VRBG 0 consists of VRBs with indexes {0, 1, 2, 3} which map to resource blocks with indexes {0, 12, 27, 39}, VRBG 1 consists of VRBs with indexes {4, 5, 6, 7} which map to resource blocks with indexes {1, 13, 28, 40}, and VRBG 2 consists of VRBs with indexes {8, 9, 10, 11} which map to resource blocks with indexes {2, 14, 29, 41}. In general, VRBG k (k=0, 1, 2, 3, . . . ) consists of VRBs with indexes {4*k, 4*k+1.4*k+2, 4*k+3} whose mappings to resource blocks are specified in the 3 GPP specification. Then the initial portion of the list of mixed VRBGs and resource block groups assigned to cell index 0 is {VRBG 0, VRBG 1, VRBG 2, VRBG 3, RBG 3, RBG 12} which is equivalent (irrespective of ordering) to resource block groups with indexes {0, 4, 9, 13, 3, 12}, cell index 1 is {VRBG 4, VRBG 5, VRBG 6, VRBG 7, RBG 7, RBG 16} which is equivalent (irrespective of ordering) to resource block groups with indexes {1, 5, 10, 14, 7, 16}, and cell index 2{VRBG 8, VRBG 9, VRBG 10, VRBG 11, RBG 8} which is equivalent (irrespective of ordering) to resource block groups with indexes {2, 6, 11, 15, 8}. Finally, the mixed list of VRBGs and resource block groups including the initial portion and the secondary portion for cell index 0, 1, 2 are then {VRBG 0, VRBG 1, VRBG 2, VRBG 3, RBG 3, RBG 12, RBG 16, RBG 15, RBG 14, RBG 11, RBG 10, RBG 8, RBG 7, RBG 6, RBG 5, RBG 2, RBG 1}, {VRBG 4, VRBG 5, VRBG 6, VRBG 7, RBG 7, RBG 16, RBG 13, RBG 15, RBG 12, RBG 11, RBG 9, RBG 8, RBG 4, RBG 6, RBG 3, RBG 2, RBG 0} and {VRBG 8, VRBG 9, VRBG 10, VRBG 11, RBG 8, RBG 16, RBG 13, RBG 14, RBG 12, RBG 10, RBG 9, RBG 7, RBG 4, RBG 5, RBG 3, RBG 1, RBG 0}, respectively. For each cell, the common control messages will be firstly allocated VRBs at the beginning of the mixed list, and then user equipment dedicated transmissions will be allocated remaining resource blocks in the mixed list. If the VRBs at the beginning of the mixed list are not used up by common control messages, the resource blocks that they map to can be used by user equipment dedicated transmissions.

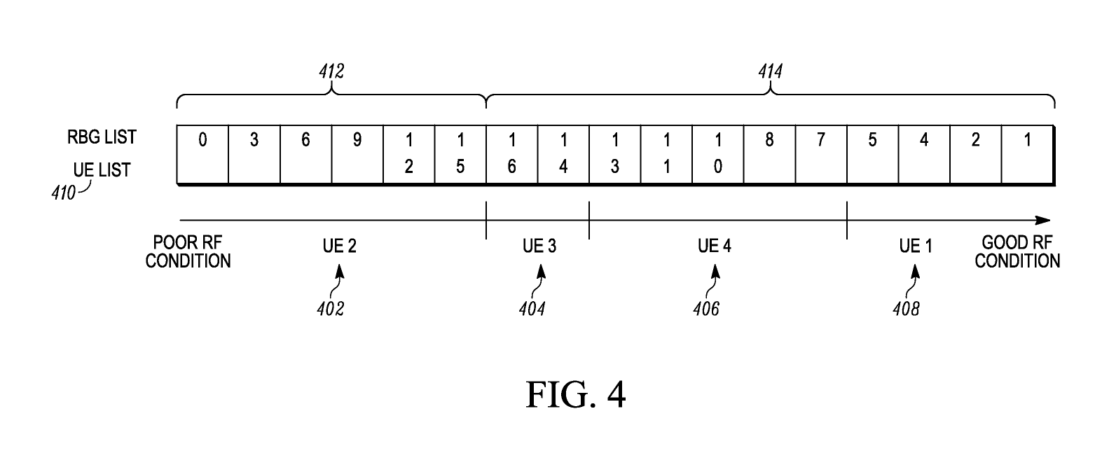

FIG. 4 shows the scheduler 102 allocating user equipment 402-408 to the list of resource block groups 410 in cell ID 0 is shown. The list of resource block groups 410 includes the initial portion 412 of the list that represents the distributed assignment of the resource block groups to cell ID 0 as described above. The second portion 414 is the distributed assignment block groups to cell ID 0 taken from the initial portions of cell IDs 1 and 2. As shown, the scheduler constructs an ordered list of user equipment 402-408 in an increasing order with regard to their channel conditions. As seen, ordered list is in rank order of the user equipment having the poorest RF conditions to the best RF conditions. Thus, the user equipment with the worst channel conditions will be assigned the first resource block groups in the list. As is understood from the list of resource block groups, these come from the initial portion of the list and they are the least likely to encounter interference from other cells as those will be the least likely to be assigned user equipment in other cells as the appear at the end of the secondary portion of the list for the other cells. The user equipment 402-408 will be sequentially assigned as per the ordered list of user equipment in the order of the list of resource block groups for each cell.

As seen in FIG. 4, the scheduler 102 has determined the order of user equipment according to increasing RF conditions to be user equipment 2 (402), user equipment 3 (404), user equipment 4 (406) and user equipment 1 (408). The scheduler 102 allocates the list of resource block groups 410 in the order provided and according to a variety of factors such as queue length, channel quality of the resource blocks and resource block groups and other known qualities. As shown, user equipment 2 (402) is assigned resource block groups {0, 3, 6, 9, 12, 15}; user equipment 3 (404) is assigned resource block groups {16, 14}; user equipment 3 (406) is assigned resource block groups {13, 11, 10, 8, 7} and user equipment 1 (408) is assigned resource block groups {5, 4, 2, 1}.

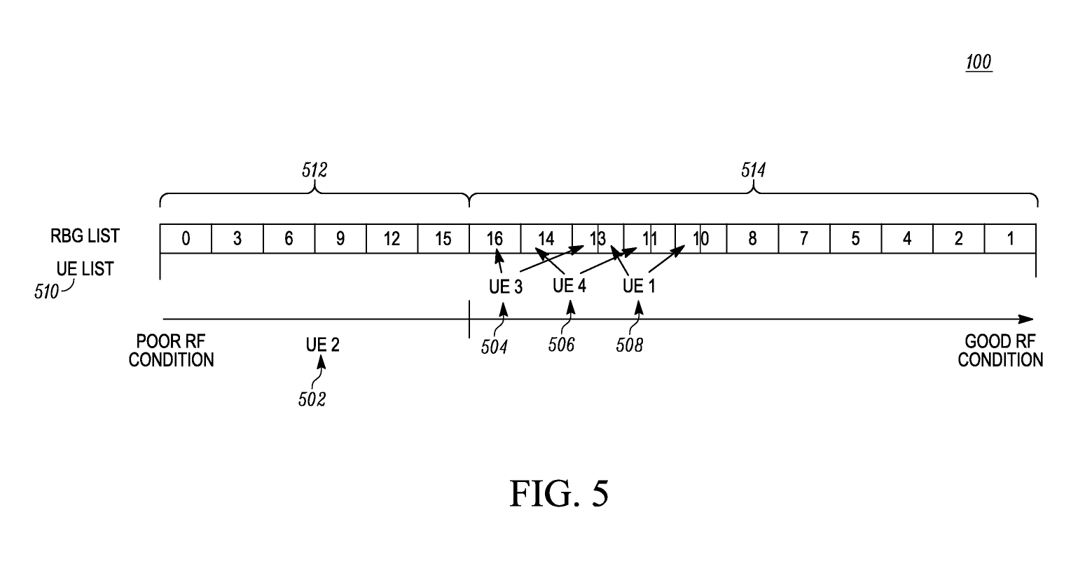

FIG. 5 illustrates an alternative embodiment of the allocation of user equipment 502-508 to the list of resource block groups 510. The allocation of user equipment 502-508 can be modified from the above description to consider the buffer size of each of the user equipment. In an embodiment shown, the buffer size is considered in the allocation of resource block groups in the secondary portion 514 of the list. Thus, the initial portion 512 is assigned to decrease the likelihood of interference between the cells, and the buffer size is considered in the secondary portion 514 to also decrease interference while increasing the degree of packing of the list of resource block groups 510. To increase packing, the allocation of the secondary portion considers the number of resource blocks required by each of the user equipment and assigns the resource blocks from the resource block groups in the same subset. This is in contrast to the example shown in FIG. 4, which assigned user equipment to an entire resource block groups without other considerations.

As seen in FIG. 5, the scheduler 102 has determined the order of user equipment according to increasing RF conditions to be user equipment 2 (502), user equipment 3 (504), user equipment 4 (506) and user equipment 1 (508). As shown, user equipment 2 (402) is assigned resource block groups from the initial portion 512 of the list 510. The scheduler determines that user equipment 3 (504) has a buffer size that requires 3 resource blocks. Thus, user equipment 3 (504) is assigned resource block 16 and at 1 resource block from resource block group 13, which is in the same subset as resource block 16. It should be noted that normally each resource group block in a 10 MHz example has 3 resource blocks, but resource group block 16 only as two since 50 resource group blocks are not evenly divisible by 3. Thus, even though three resource blocks were needed, receiving resource block group 16 only supplied two out of the needed three, so one more was needed. User equipment 4 (506) is determined by the scheduler to require 4 resource blocks. The scheduler therefore allocates resource block group 14, which has 3 resource blocks, and one resource block from resource block group 11, which is in the same subset as resource block 14. User equipment 1 (508) is determined to require 4 resource blocks according to the size of its buffer. The next resource block group to be assigned is resource block 13, which has had 1 resource block assigned to user equipment 3 (504). The remaining 2 resource blocks of resource block group 13 are assigned to user equipment 1 (508). The scheduler also assigns 2 resource blocks from resource block 10, which is in the same subset as resource block 13. In this manner, the scheduler can optimize the packing of the second portion of the list of resource blocks. This principles described can also apply to the initial portion of the list.

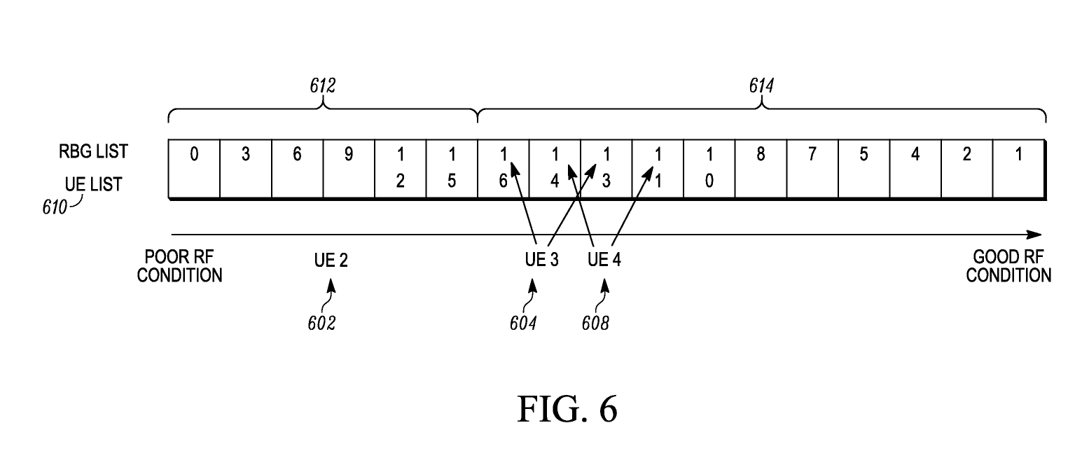

FIG. 6 shows another embodiment of the scheduler 102 allocating user equipment 602-608 to the list of resource blocks 610 for a cell ID 0. In this embodiment, the allocation of the initial portion 612 of the list is performed as described above. The scheduler 102, however, takes into consideration the measurements of the cells by the user equipment to allocate the second portion 614 of the list. In particular, the scheduler takes into consideration the interference from adjacent cells, cell ID 1 and cell ID 2. These adjacent cells are the cells from which the second portion 614 of the list of resource block is composed. If the scheduler determines that the interference from cell ID 2 is greater than from cell ID 1, then the scheduler allocates the resource block groups in the secondary portion 614 that are obtained from the cell ID 1. As shown, the user equipment 3 (604) is assigned to resource blocks 16 and 13, which are obtained from the initial portions of the list from cell ID 1. If the scheduler determines that the interference from cell ID 1 is greater than from cell ID 2, then the scheduler allocates the resource block groups in the secondary portion 614 that are obtained from the cell ID 2. As shown the user equipment 4 (606) is assigned to resource blocks 14 and 11, which are obtained from the initial portions of the list from cell ID 2. Similar principles can be developed when considering load between cells in addition to interference levels

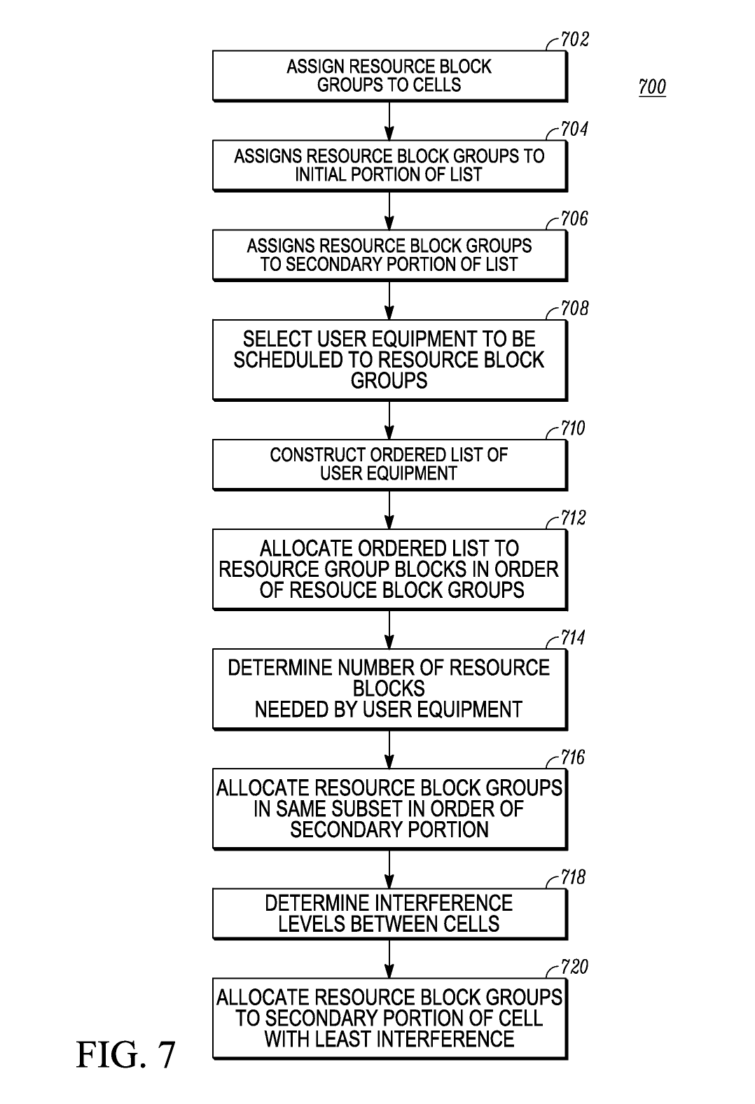

FIG. 7 illustrates a flow chart 700 of the principles described above. For every cell, the scheduler 102 assigns 702 the resource block groups in a given frequency bandwidth to the cells (cell ID 0, cell ID 1, cell ID 2) of a base station 110. The scheduler assigns 704 each of the resource block groups to an initial portion of the list for each cell such that the resource block groups are distributed across the plurality of cells in a noncontiguous order and spaced out in frequency. The pattern of the initial portions is shown above. The scheduler also assigns 706 the resource block groups to a secondary portion of the lest for each cell such that they are assigned in a reverse order and alternating from the initial portion of the list of resource block groups of each of the other plurality of cells. Thus, the resource block groups from the other cells that are at the end of the initial list are assigned to the start of the secondary lists. This allows the resource block groups from the beginning of the initial portion to be at the end of the secondary lists and be less likely to have user equipment assigned to those resource block groups.

The scheduler selects 708 a set of user equipment to be scheduled using the resource block groups in the lists. As is understood, the selection of the user equipment can be based on priority metrics such as PF metric, delay budget metrics and other metrics. The scheduler then constructs 710 an order list of the user equipment in an increasing order with regard to their channel conditions include RF conditions. Thus, the user equipment with the least desirable channel conditions will be first in the ordered list. The ordered list can also be a dynamic list that may change over time and for frames. The scheduler can allocate 712 the ordered list of user equipment to resource block groups in the order of the list of resource block groups found in the initial portion and the secondary portion. The number of resource block groups assigned to each user equipment can be determined by various factors including queue length.

In an embodiment, the scheduler can allocate the secondary portion of the list using the buffer size of the user equipment. In this embodiment, the scheduler determines 714 the number of resource blocks that the user equipment requires and allocates 716 the resource block from the resource block groups in the same subset and in the order of the secondary list. In another embodiment, the scheduler can allocate the secondary portion of the list using the conditions of neighboring cells. In this embodiment, the scheduler determines 718 the interference levels of the neighboring cells and allocates 720 the resource block groups in the initial portion of the cell that causes the least interference followed by the resource block groups of the initial portion of the remaining cells. Similar considerations can be made by the scheduler by determining the load levels of the neighboring cells and allocating user equipment to the secondary portion according the lower load level in a manner similar to interference levels. As is understood from this description, variations and combinations of these embodiments can be performed to maximize packing within a cell and reduce interference and load levels between cells.

The principles described above as applied to resource blocks and resource block groups can also be applied to virtual radio blocks as applied to RAT 2. Thus, a primary portion and secondary portion of a list of virtual radio blocks can be assigned. For example, the virtual radio groups can be grouped into bundles of 4 (virtual radio block index number 4i, 4i+1, 4i+2, 4i+3, I=0, 1, . . . ) so that the virtual radio blocks in each group will complement each other to form a whole resource block. When using RAT 2 distributed in groups of 4, it may be difficult to pack resource block groups use RAT 0 so RAT 2 can be used.

In addition, power variations can be considered. The power to be used for transmission to a given user equipment may depend on channel quality indices. The power is signaled to the user equipment using RRC messages and cannot be changed every sub-frame. The principle of user equipment power may, however, be adapted more frequently by broadcasting a power provide in each resource block group. Due to assignment patterns of user equipment to resource block groups, the power used for transmission by the different cells can vary from resource block group to resource block group and from frame to frame. Since the user equipments report wideband CQI, which is an average over all resource block groups, the estimate of CQI is a biased estimate. To correct for this, a weighting factor to each resource block group can be applied, and this contributes to a variation in the amount of power transmitted in each resource block group by different cells. In addition, the weighting factor can be applied to the base station after the CQI reports are received or can be conveyed to the user equipment to allow them to compute a weighted-average CQI. The weighting factors can also be based on the exchange of reports between neighboring cells.

The reuse patterns described provide a set of non-contiguous, frequency diverse resources to each cell, wherein the pattern aligns with the resource block group boundaries that are specified by LTE. The resulting interleaved frequency reuse pattern allows each member of the preferred frequency reuse group to support frequency diverse resource allocations to reduce susceptibility to fading, while reducing inter-cell interference. These principles further reduce inter-cell interference by assigning physical resources to user equipment in order of increasing C/I measure (i.e., weakest UE goes first). This increases the probability that edge of cell users will be given resources in the preferred bands, thereby reducing the likelihood of interfering with the adjacent cell. Finally, the use of data driven resource assignment sequences for RAT 0 and RAT 1 allocations provides a simple mechanism for applicable tailoring to meet various performance objectives.

The principles described above are used in the embodiments where there is anticipated a lightly loaded frequency spectrum. In the case of a fully loaded or heavily loaded frequency spectrum, interference and large loads across the spectrum are expected. In this case allocation of user equipment to the frequency spectrum is adapted. In this scenario, RAT 0 allocations are specified in terms of the resource block groups, which nominally consist of P number of resource blocks. The value of P is dependent upon system bandwidth and is indicated above for the different frequency bandwidths. Each resource block group consists of P contiguous resource blocks, except for the highest frequency RBG which may contain less than P resource blocks. This is illustrated in the following figures, which reflects a 10 MHz deployment where all resource block groups include three resource blocks, except RBG 16 which consists of only two resource blocks.

In order to simplify the scheduling algorithm, RAT 0 allocations will always include an integer multiple of P resource blocks. The odd sized resource block groups (if present) will typically be used for RAT 2 allocations as indicated above. The resource block group assignment sequence for RAT 0 allocations depends on the PDSCH utilization in the corresponding TTI. Specifically, if the PDSCH is nearly full and RAT 2 assignment resulted in a partially occupied resource block group, then there is no motivation to exploit the preferred frequency reuse pattern in the downlink transmission for this TTI. In this case, the primary objective is to maximize the probability that the scheduler is able to assign resource blocks for the last allocations (i.e., to avoid packing problems). Since RAT 1 allocations are assigned last, and RAT 1 requires that all assigned resource blocks for a given allocation are part of the same RBG subset (refer to the last row in the figure above), the scheduler must ensure that the last PDSCH assignments include PRBs that are part of the same RAT 1 assignment space as the partially allocated RBG that remained after completion of RAT 2 assignments. To that end, the scheduler must calculate the appropriate starting RBG using the following formula:

RBG_Start=((Lowest RBG # used for RAT 2 allocation MOD P)+1) MOD P,

where Lowest RBG # used for RAT 2 allocation=FLOOR(lowest PRB # used for RAT 2 allocation/P). After determining the appropriate starting point (RBG 0, RBG 1 or RBG 2), the scheduler follows the assignment sequence by sequentially listing the resource block groups of the same subsets starting with resource block groups of subset 0 and then the resource block groups of subset 1 and subset 2. Thus, in the 50 MHz range the resource block assignment sequence is {0, 3, 6, 9, 12, 15, 1, 4, 7, 10, 13, 2, 5, 8, 11, 14}. These principles apply to other frequency bandwidths, e.g. 5 MHz, 20 MHz. This sequence also reflects a circular sequence (i.e., if the starting point is not the first entry, then the last entry in the list is followed by the first entry).

It is noted that if the PDSCH is not nearly full or if RAT 2 assignment does not result in a partially occupied RPB, then the scheduler will attempt to mitigate inter-cell interference by assigning resource blocks in accordance with a prescribed frequency reuse pattern where cell ID 0 favors resource block groups in subset 0, cell ID 1 prefers resource block groups in subset 1 and cell ID 2 prefers resource block groups in subset 2. In this case, the scheduler 102 determines the applicable starting resource block group and associated resource block group assignment sequence based on its cell ID. As such, in the 10 MHz frequency bandwidth the assignment sequence for cell ID 0.

It is also noted that RAT 1 allocations are specified in terms of resource block group subsets which are non-contiguous. In order to minimize the likelihood of encountering packing problems, the RAT 1 allocations are assigned in order of size from largest to smallest. For RAT 1 assignments, the scheduler 102 utilizes the same resource block assignments sequences discussed above beginning with the resource block group that was next in lie for RAT 0 assignment. Since the scheduler design limits RAT 1 allocations to no more than the number of resource blocks in a subset minus 1, the corresponding assignments will not occupy an entire resource block group. Furthermore, RAT 1 allocations may span two resource block groups that are in the same resource block subset. If the scheduler is unable to assign a RAT 1 allocation starting at the current resource block group because the next resource block group in the sequence is in a different resource block subset, then the scheduler will skip over the remainder of the current resource block group and begin assignment within the next resource block group in the sequence. The unassigned resource block groups may be assigned later if additional allocations remain to be processed after the resource block group assignment sequence has completed.

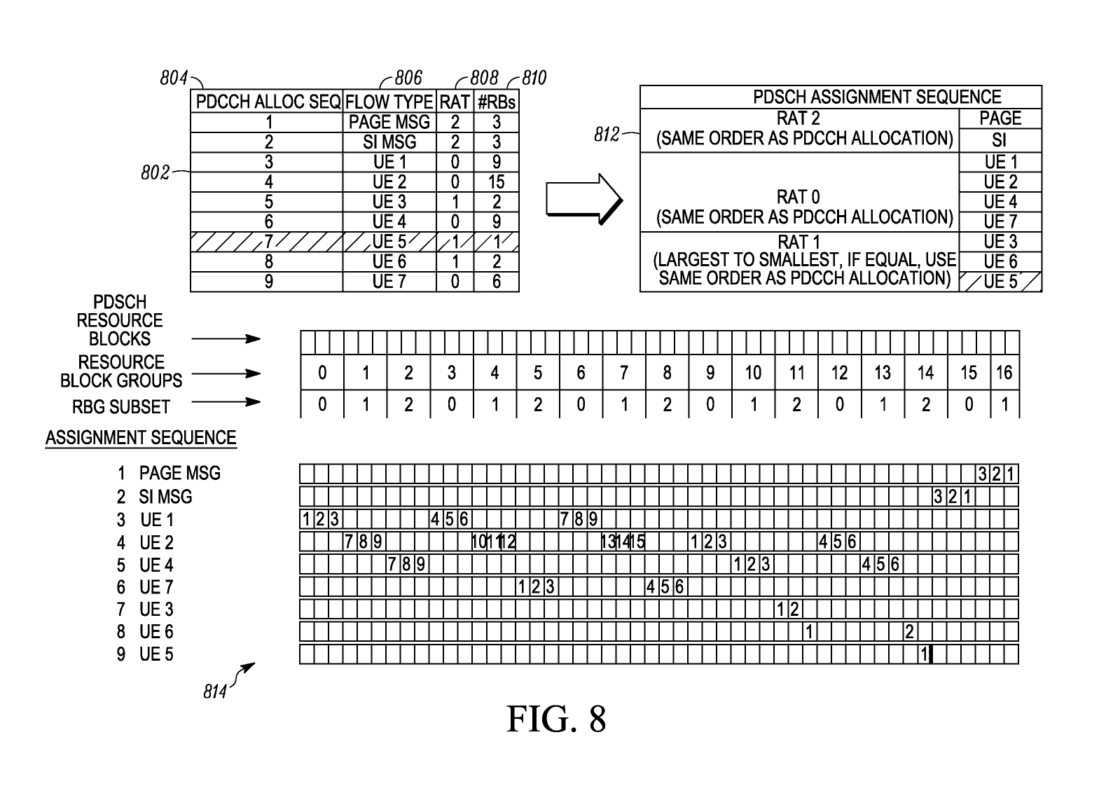

Turning to FIG. 8, an example is shown that illustrate the sequence of PDSCH allocations in accordance with the principles described for a fully or nearly fully loaded resource assignment. FIG. 8 includes a table 802 of the PDCCH allocations 804, flow types 806, associated RAT 808 and associated number of resource blocks 810. In addition, a table 812 showing the PDSCH assignment sequence for these element. As understood, the PDSCH assignment procedure reorders the input sequence to ensure that RAT 2 assignments are provided first, followed by RAT 0 and RAT 1. The modified sequence is illustrated in table 812. The resulting sequence of assignments is illustrated in connection with reference number 814, where the numbers indicated in the resource blocks reflect the order in which the algorithm assigns resources for the associated allocation. Note that frequency diversity is provided for RAT 0 (and some RAT 1) allocations.

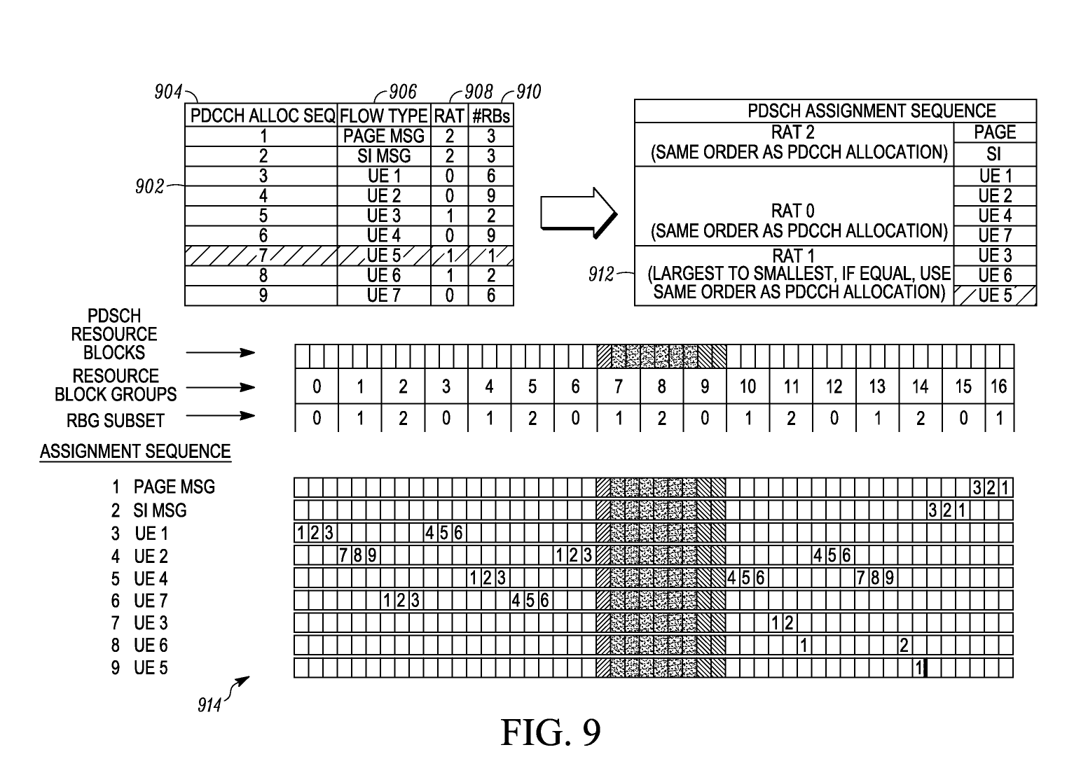

Turning to FIG. 9, another example is shown that illustrate the sequence of PDSCH allocations in accordance with the principles described for a fully or nearly fully loaded resource assignment. FIG. 9 includes a table 902 of the PDCCH allocations 904, flow types 906, associated RAT 908 and associated number of resource blocks 910. In addition, a table 912 showing the PDSCH assignment sequence for these element. In this example, the center resource blocks are used for PBCH and/or Sync Signal transmission and are therefore reserved and not available for allocation. This is illustrated by the dark grey resource blocks in the figure. In order to simplify the scheduler algorithm, these resource blocks are considered unusable by the resource allocation procedure. As in example of FIG. 8, The PDSCH Assignment procedure reorders the input sequence to ensure that RAT 2 assignments are provided first, followed by RAT 0 and RAT 1. The modified sequence is illustrated in the table 912. The resulting sequence of assignments is illustrated in connection with reference number 914. Note that the allocation skips over the resource block group that overlaps the PBCH/Sync Signal space in this scenario.

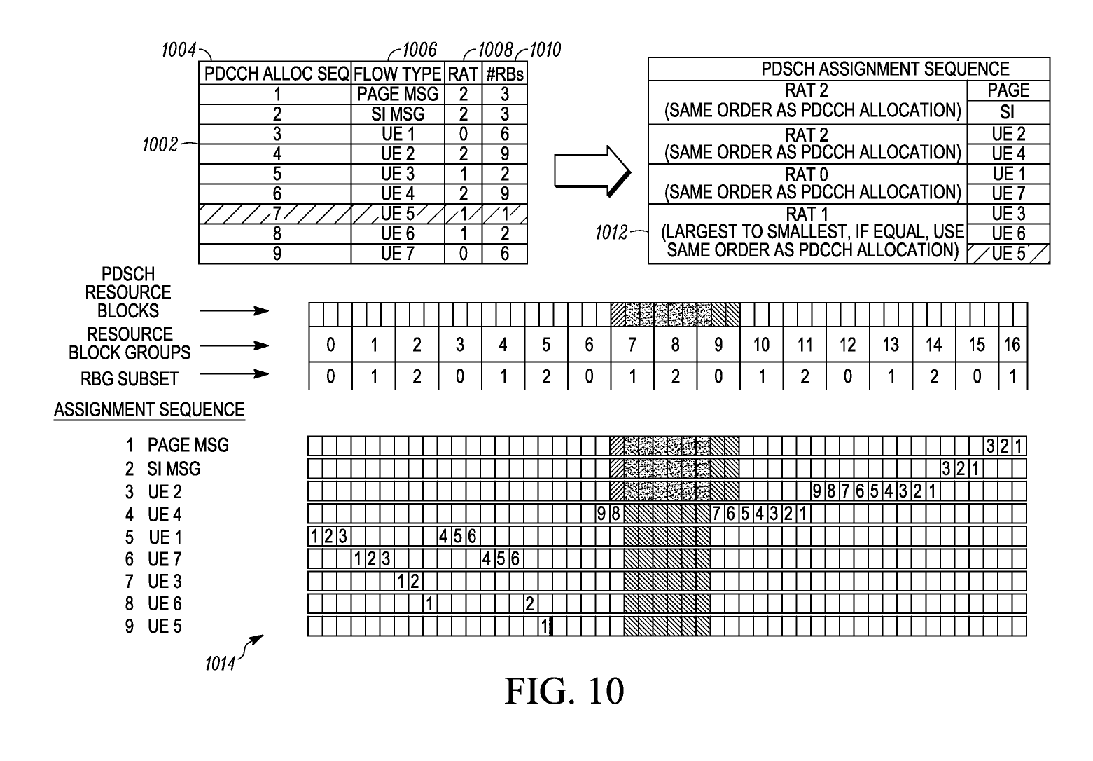

Turning to FIG. 10, another example is shown that illustrate the sequence of PDSCH allocations in accordance with the principles described for a fully or nearly fully loaded resource assignment. FIG. 10 includes a table 1002 of the PDCCH allocations 1004, flow types 1006, associated RAT 1008 and associated number of resource blocks 1010. In addition, a table 1012 showing the PDSCH assignment sequence for these element. In this example, the center resource blocks are used for PBCH and/or Sync Signal transmission, which is illustrated by the dark grey resource blocks, and these resource blocks are considered unusable by the resource allocation procedure. The scheduler will assign adjacent resources blocks in the reserved resource block groups since RAT 2 requires a contiguous set of resource blocks. Note that the transport block size does not be increased. Rather, the MCS will be reduced, thereby providing higher reliability for this transmission, due to the effective coding gain. As in the examples of FIGS. 8 and 9, the PDSCH Assignment procedure reorders the input sequence to ensure that all RAT 2 assignments are provided first, followed by RAT 0 and RAT 1. The modified sequence is illustrated in connection with reference number 1014.

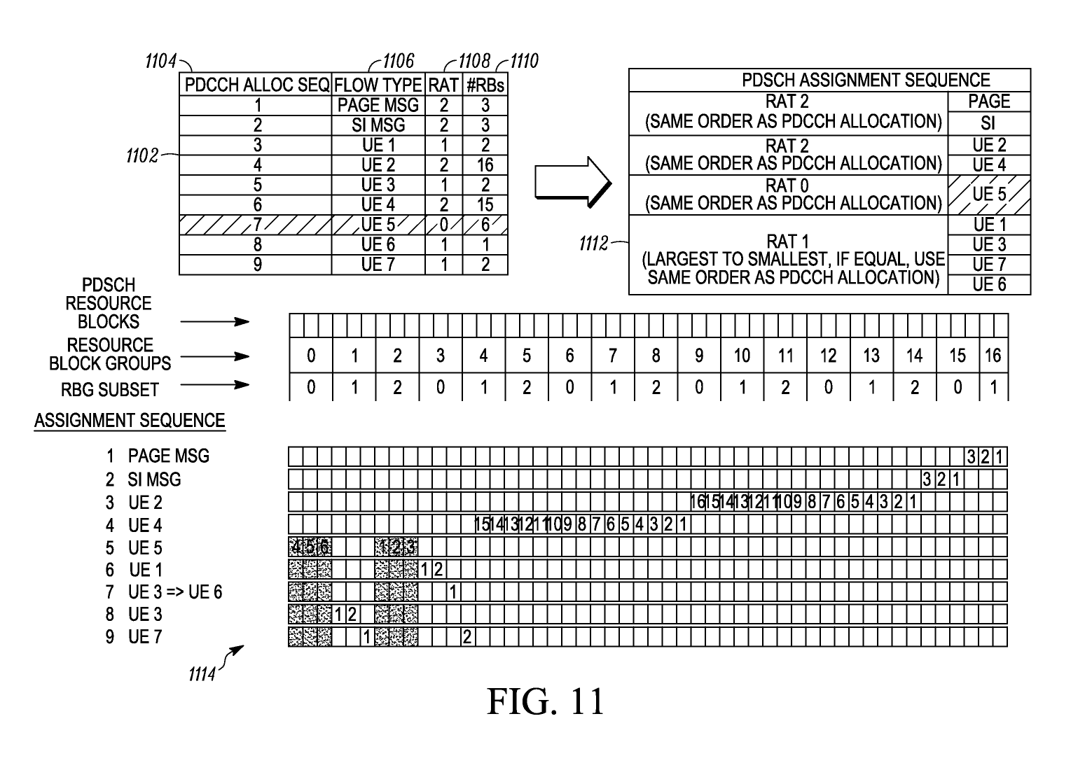

Turning to FIG. 11, another example is shown that illustrate the sequence of PDSCH allocations in accordance with the principles described for a fully or nearly fully loaded resource assignment. FIG. 11 includes a table 1102 of the PDCCH allocations 1104, flow types 1106, associated RAT 1108 and associated number of resource blocks 1110. In addition, a table 1112 showing the PDSCH assignment sequence for these element. In this example, the PDSCH Assignment procedure reorders the input sequence to ensure that all RAT 2 assignments are provided first, followed by RAT 0 and RAT 1. The modified sequence is illustrated in the table 1112. The resulting sequence of assignments is illustrated in connection with reference number 1114. In this scenario, during the seventh assignment, the scheduler is unable to assign resources to UE 3 at the desired position of the resource block assignment sequence (i.e., at resource block group 3). This is because UE 3 requires two resource blocks (using RAT 1), but the next available resource block in resource block group 3 is the only one remaining in subset 0. The scheduler therefore searches ahead in the sorted list of RAT 1 user equipment to find the first entry that will fit in the available space. In this scenario, user equipment 6 is the first entry that requires only one resource block, so the scheduler adjusts its nominal RAT 1 processing sequence and assigns resources for UE 6 at this point. After filling the available PDSCH space in resource block group 3, the algorithm continues processing at the next resource block group in the prescribed resource block assignment sequence, starting with the entry that triggered the re-sequencing procedure (i.e., user equipment 3).

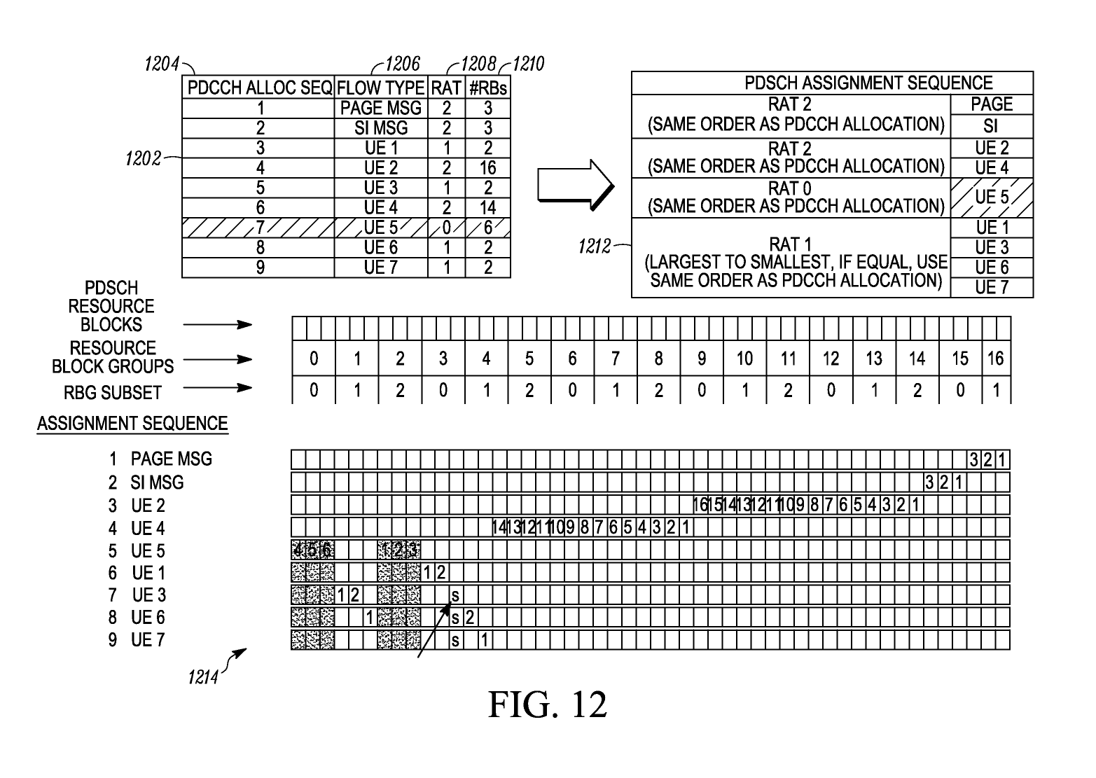

Turning to FIG. 12, another example is shown that illustrate the sequence of PDSCH allocations in accordance with the principles described for a fully or nearly fully loaded resource assignment. FIG. 12 includes a table 1202 of the PDCCH allocations 1204, flow types 1206, associated RAT 1208 and associated number of resource blocks 1210. In addition, a table 1212 showing the PDSCH assignment sequence for these element. In this example, the PDSCH Assignment procedure reorders the input sequence to ensure that all RAT 2 assignments are provided first, followed by RAT 0 and RAT 1. The modified sequence is illustrated in the table 1212. The resulting sequence of assignments is illustrated in connection with reference number 1214. In this scenario, during the seventh assignment, the scheduler is unable to assign resources to user equipment 3 at the desired position of the resource block group assignment sequence (i.e., at resource block group 3). This is because user equipment requires two resource blocks (using RAT 1), but the next available resource block in resource block 3 is the only one remaining in RBG subset 0. At this point, the scheduler searches ahead in the sorted list of RAT 1 user equipment to find the first entry that will fit in the available space. Thus, there are no user equipment that require only one resource block, so the scheduler skips to the next available resource block group in the resource block group assignment sequence (i.e., resource block group 1) to continue the assignment procedure, leaving an unassigned resource block in resource block group 3. Similarly, during the last assignment, the scheduler is unable to assign adequate resources to user equipment 7 in resource block 4. Since the two remaining resource blocks are in different subsets, the scheduler is not able to fulfill user equipment 7's allocation of two resource blocks, so it is truncated to one resource block.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method comprising:
assigning an initial portion of a list of resource block group for each of a plurality of cells such that the resource block groups are distributed across the plurality of cells in a noncontiguous order spaced out in frequency and
assigning a secondary portion of the list of resource block groups for each of a plurality of cells wherein the secondary portion is comprised of the initial portion of the list of resource block groups of each of the other plurality of cells.

2. The method of claim 1 wherein the secondary portion of the list of resource block group is assigned in a reverse order and alternating from the initial portion of the list of resource block group of each of the other plurality of cells

3. The method of claim 1 further comprising allocating the assigned list of resource block groups to user equipment in a sequential order of the assigned resource block groups of the initial portion and the secondary portion.

4. The method of claim 1 further comprising:
allocating the initial portion of the list of resource block groups to user equipment and
allocating the secondary portion of the list of resource block groups to user equipment after the initial portion is allocated.

5. The method of claim 1 further comprising:
allocating the initial portion of the list of resource block groups to user equipment and
allocating the secondary portion of the list of resource block groups to user equipment after the initial portion is allocated according to a buffer size of the user equipment.

6. The method of claim 5 wherein allocating the secondary portion of the list of resource block groups comprises allocating a first user equipment to a first resource block group in the secondary portion and at least a first resource block of a second resource block group in a same subset as the first resource block group.

7. The method of claim 6 further comprising allocating a second user equipment to a third resource block group in the secondary portion in another subset and at least a first resource block of a forth resource block in a same subset as the third resource block.

8. The method of claim 1 further comprising:
allocating the initial portion of the list of resource block groups of a first cell to user equipment;
allocating the initial portion of the list of resource block groups of a second cell to user equipment after the initial portion of the first cell is allocated when the user equipment measures larger interference in a third cell, and
allocating the initial portion of the list of resource block groups of the third cell to user equipment after the initial portion of the second cell is allocated.

9. The method of claim 1 further comprising allocating the list of resource block groups to a plurality of user equipment wherein each of the plurality of user equipment are allocated in an order from weakest channel condition to strongest channel condition.

10. The method of claim 1 further comprising modifying the secondary portion of the list of resource block groups for one of the plurality of cells when cell load information from another of the plurality of cells is available.

11. The method of claim 10 wherein modifying the secondary portion of the list of resource block groups comprises prioritizing the initial portion of the list of resource block groups from a first of another of the plurality of cells when the load on the initial portion of list of resource block groups for a second of another of the plurality of cells is greater than the load on the initial portion of the list of resource blocks of the first of another of the plurality of cells.

12. An apparatus comprising:
a transceiver, and
a processor coupled to the transceiver to transmit and receive data using an initial portion of a list of resource block group for each of a plurality of cells such that the resource block groups are spread across the plurality of cells in a noncontiguous order spaced out in frequency and a secondary portion of the list of resource block groups for each of a plurality of cells wherein the secondary portion is comprised of the list of resource block groups of each of the other plurality of cells.

13. The method of claim 12 wherein the processor allocates the initial portion of the list of resource block groups to user equipment and allocates the secondary portion of the list of resource block groups to user equipment after the initial portion is allocated.

14. The method of claim 12 wherein the processor allocates the initial portion of the list of resource block groups to user equipment and allocates the secondary portion of the list of resource block groups to user equipment after the initial portion is allocated according to a buffer size of the user equipment.

15. The method of claim 14 wherein the processor allocates the secondary portion of the list of resource block groups by allocating a first user equipment to a first resource block group in the secondary portion and at least a first resource block of a second resource block group in a same subset as the first resource block group.

16. The method of claim 15 wherein the processor further allocates a second user equipment to a third resource block group in the secondary portion in another subset and at least a first resource block of a forth resource block in a same subset as the third resource block.

17. The method of claim 12 wherein the processor allocates the initial portion of the list of resource block groups of a first cell to user equipment, allocates the initial portion of the list of resource block groups of a second cell to user equipment after the initial portion of the first cell is allocated when the user equipment measures larger interference in a third cell, and allocates the initial portion of the list of resource block groups of the third cell to user equipment after the initial portion of the second cell is allocated.

18. The method of claim 12 wherein the processor allocates the list of resource block groups to a plurality of user equipment wherein each of the plurality of user equipment are allocated in an order from weakest frequency condition to strongest frequency condition.

19. The method of claim 12 wherein the processor modifies the secondary portion of the list of resource block groups for one of the plurality of cells when cell load information from another of the plurality of cells is available.

20. The method of claim 19 wherein the processor modifies the secondary portion of the list of resource block groups by prioritizing the initial portion of the list of resource block groups from a first of another of the plurality of cells when the load on the initial portion of list of resource block groups for a second of another of the plurality of cells is greater than the load on the initial portion of the list of resource blocks of the first of another of the plurality of cells.
